(19) United States
(12) Patent Application Publication
(10) Pub. No.: US 2003/0064811 A1
(43) Pub. Date: Apr. 3, 2003

(54) Gaming device with write only mass storage

(76) Inventor: Greg Schlottmann, Reno, NV (US)

Correspondence Address: Chad W. Miller, Weide & Associates, Ltd., 330 South 3rd Street, 11th Floor, Suite 1130, Phoenix Bldg., Las Vegas, NV, 89101, US

(21) Appl. No.: 09/967,517

(22) Filed: Sep. 28, 2001

(51) Int. Cl. A63F 13/00

(52) U.S. Cl. 463/43

(57) ABSTRACT

A method and apparatus for collecting data in read-only manner from a gaming system is disclosed. In one embodiment of the invention a record-only data collection device is configured to temporarily interface with a gaming machine that has or is suspected of malfunction. During gaming machine play or use, operation data regarding any aspect of the gaming machine is provided to the record-only data collection device and the operation data stored thereon. Media may be associated with the data collection device. Upon occurrence of a malfunction or fault of the gaming machine, the media or the data collection device, having the operation data stored thereon, may be retrieved from the gaming machine. The operation data may then be provided to any location or any device and analyzed to determine the cause of the fault or malfunction. In various other configurations the data collection device may be remote from the gaming system and collect data over a radio or network link. The operation data may comprise information collected for purposes other than gaming machine malfunction monitoring.

### FIELD OF THE INVENTION

The present invention relates to data storage for gaming machines and in particular to a method and apparatus for storing game or system data on a data storage device.

### BACKGROUND OF THE INVENTION

Modern gaming machines, such as those used in wagering games, are enabled by use of complex hardware and software systems that operate together to provide an interactive gaming experience to a user. Different versions of the software may be enabled for use and are configured to execute on a processor or other hardware device. As can be appreciated numerous interfaces are included in the gaming machine to facilitate play. For example, a user interface is provided to obtain user input. Likewise, the processor interacts with and at least partially controls a display, a network interface, various security devices and payment acceptance and payout apparatus. To operate as desired, the devices must interact without failure. As can be appreciated, significant revenue may be lost by the owner or operator of the gaming machine if the hardware and software systems do not operate properly.

A further consideration of gaming machine design, construction, and operation is the numerous regulations and rules that must be complied with. These rules are promulgated and enforced by various governmental bodies. For example, in the state of Nevada, the Nevada Gaming Commission regulates gaming. Some regulations implement gaming machine configuration requirements to prevent users or owners of the gaming machine from tampering with the gaming machine's operation. In one example situation the software code that controls the gaming machine's operation is approved by a regulatory body for use in conjunction with a gaming machine. Once approved, it is unlawful to alter the software code without approval of the regulatory body because such an alteration may cause the gaming machine to inaccurately award winning events to a player or deny a winning event to a player.

As a result, regulatory bodies may prohibit a gaming machine from containing or attaching to a data storage device that could be used to re-write or alter the software code that controls gaming device operation. While gaming regulations must be complied with and are important to maintain a high level of integrity in the gaming industry, these regulations may place a burden on gaming machine designers, manufactures and game technicians. One such burden is the difficulty in diagnosing and troubleshooting a malfunctioning gaming device. For example, if the software code or the hardware that enables the gaming machine has a glitch, data error, or other anomaly that cause the game to malfunction, it may be helpful to store data about the operation of the machine prior to and at the time of the malfunction. Lack of such data is a serious drawback to restoring malfunctioning gaming devices to consistent and desired operation and results in gaming devices being out of service for longer periods of time. The invention overcomes the drawbacks created by prior gaming machines and gaming regulations.

### SUMMARY OF THE INVENTION

In one embodiment the invention comprises a system configured to interface with a gaming machine and store data regarding gaming machine play. In such an embodiment a gaming machine interface is configured to collect operation data from the gaming machine and provide the operation data to an output interface. A write-only device is also provided comprising an input interface configured to connect to the output interface and receive operation data and a media interface configured to communication with the input interface and write operation data to a media.

The operation data may comprise data selected from the group consisting of player tracking data, video data, money intake data and payout data. The output port may include an output port driver. The system may be integrated within a housing that also contains the gaming machine. It is contemplated that in one embodiment the first interface may connect to a processor and the input interface and the output interface may operate under the universal serial bus standard.

In an exemplary method of operation, a method for obtaining data concerning gaming system operation while preventing unauthorized writing of data to the gaming system is provided. The method comprises establishing a communication link between a record-only data recording system and the gaming system. Thereafter initiating operation of the gaming system and capturing data regarding gaming system operation. Next, storing the data on a media wherein the media interfaces with the record-only data recording system.

In various embodiments, the gaming system comprises a slot machine or video gaming machine configured to provide a wagering event to a player. The data regarding gaming system operation may comprise system security data and the media may comprise a hard-disk drive. In another embodiment, the record-only data recording system is a record-only device only when connected to the gaming system and is a read/write device when connected to a device other than a gaming system.

In one embodiment the method may further include obtaining data that is stored on the media, analyzing the data, and modifying the gaming system based on the analyzing. Analyzing the data may comprise comparing the data to data resulting from desired gaming system operation. Furthermore, modifying may comprise modifying the software/hardware of a gaming machine to achieve desired operation.

### DESCRIPTION OF THE DRAWINGS

FIG. 1 is a block diagram of an example environment of use for the invention.

FIG. 2 is a process diagram of one example embodiment of the invention.

FIG. 3 is a detailed block diagram of the invention.

FIG. 4 is an operational flow diagram of an example method of operation of the invention.

### DETAILED DESCRIPTION OF THE INVENTION

The invention is a method and apparatus for monitoring and data recoding on a gaming machine. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention. The various features of the invention may be combined in any combination or enabled alone.

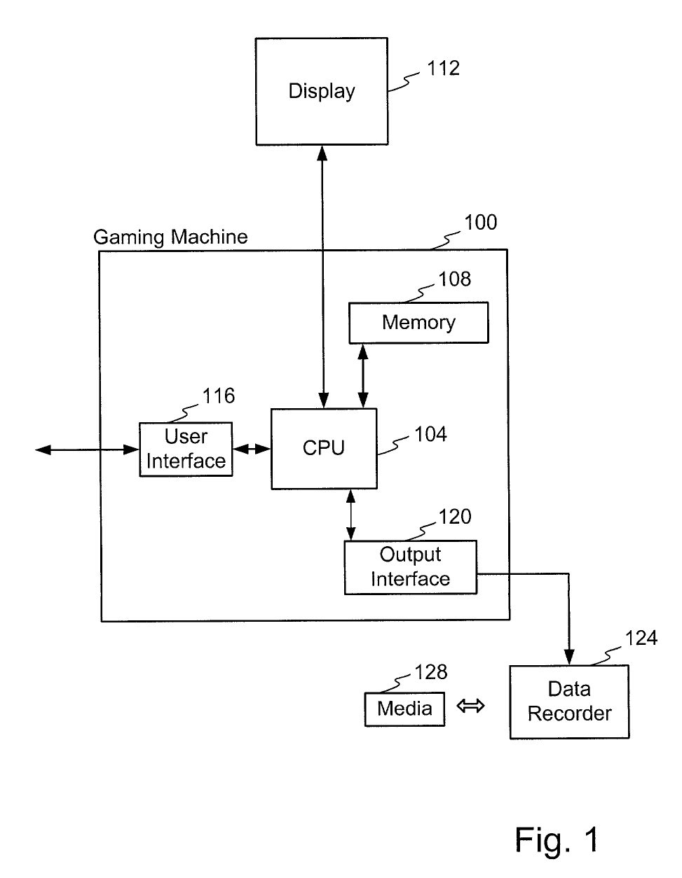

In reference to FIG. 1, one example embodiment of a gaming machine 100 may include a CPU or processor 104 in communication with memory 108. The gaming machine 100 may be configured to execute and provide a wagering or gambling event to a player. The memory 108 may include both volatile and non-volatile memory and may include but is not limited to any type of RAM, hard disk drive type memory, CD or DVD type optical memory devices, flash memory, Zip disks, IBM disk on a chip, ZIO USB drive, IBM micro-drive, battery backed memory or tape storage. The ZIO USB drive and micro-drives are available from MicroTech International, Inc. located at Guilford, Conn. In one embodiment the memory 108 may be remotely located from the gaming machine 100 and accessible over a network. It is contemplated that the memory 108, i.e. computer readable media, store computer readable code that is configured to execute game play on the gaming machine 100.

The CPU 104 also connects to a display module 112 and a user interface 116. The display module 112 may comprise any device or system capable of displaying a game to a user or player. Examples of display devices 112 include, but are not limited to, a CRT display, plasma screen, LCD, active matrix, or TFT type display. The user interface 116 may comprise any configuration of buttons, touch screen, mouse, keyboard, or other means to receive input from a player. Additional user interfaces 116 may be provided to allow access to the hardware and software components of the gaming device 100 by service technicians, or software or hardware engineers.

In the example gaming machine shown, an output interface 120 is in communication with the CPU 104. The output interface 120 is further configured to communicate or connect to an a media or data recorder 124, shown in FIG. 1 as being external to the gaming machine 100. In another embodiment the media recorder 124 as contemplated by the invention may be internal to the gaming machine 100. In one embodiment the output interface 120 is a write-only device. Hence it would not be able to receive data from the recorder 124. The data recorder 124 may be configured to accept a removable media 128. The removable media 128 may comprise any type media capable of storing operation data as provided or generated by the gaming machine 100. The media 128 may comprise flash memory, CD-R/W memory, DVD memory, tape type memory, hard disk drive memory, disk on a chip, battery backed memory, IBM micro drive, tape memory, zip drive memory, or any other type of memory able to record and store operation data or any type of data from the gaming machine. In one environment the operation data (that is recorded) comprises data regarding the code, data contained in and/or executed by the CPU 104, or the state of the user interface systems 116, memory systems 108, and display systems 112. Recordation of such information may prove beneficial when trouble-shooting a machine 100 prone to software/hardware malfunctions.

In various embodiments the data recorder 124 is a device configured to only record data as provided via the output interface 120. Configuring the data recorder 124 to only record data, and hence not be able to output data, provides the advantage of eliminating the ability to write code or modify code on the gaming machine via the output interface 120. This prevents tampering or dishonest modification to the gaming machine 100. In another embodiment the data recorder 124 also includes output or write capability. This is but one possible configuration of a gaming machine 100. It is contemplated that other gaming machine 100 configurations may be implemented without departing from the scope of the invention.

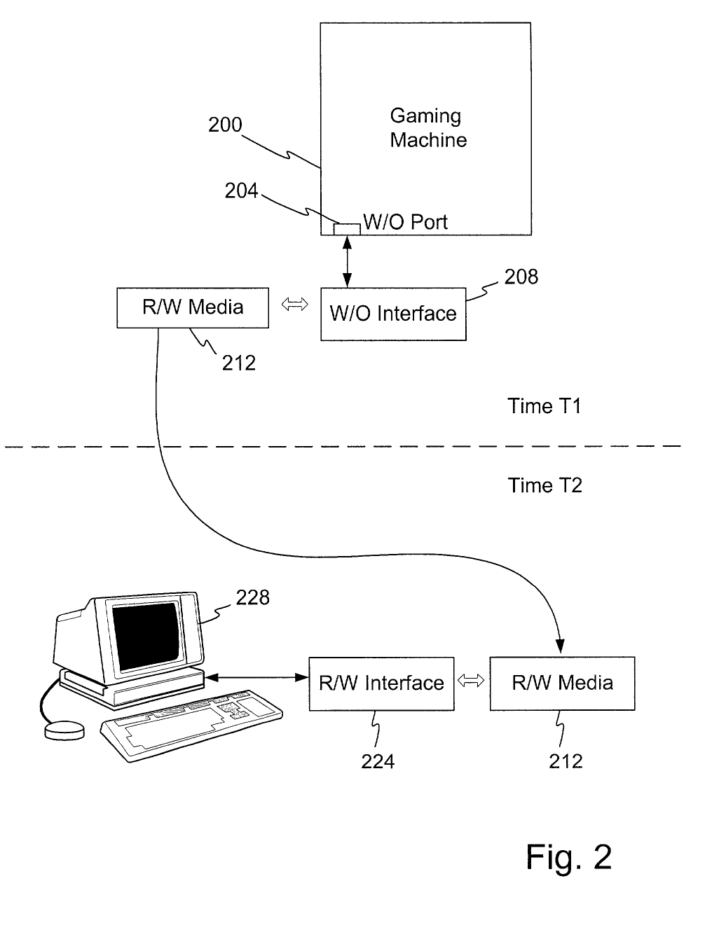

FIG. 2 illustrates a process diagram of one example embodiment of the invention. The process diagram of FIG. 2 is separated as events occurring at or before a time T1, shown at the top half of FIG. 2, and events occurring at or after a time T2, shown at the bottom half of FIG. 2. It is assumed that in this discussion time T1 occurs before time T2. A gaming machine 200 includes a write/only port 204. A write/only interface 208 connects to or communicates with the write/only port 204 to receive operation data regarding gaming machine 200 operation. Examples of operation data includes but are not limited to every event and state change with a date and time stamp, credit information, stack data, network traffic, debug information, statistics, accounting information, security information, and/or wide area progressive network traffic

A read/write media 212 is provided for use with the write/only interface 208. In the embodiment shown in FIG. 2, the read/write media 212 may be removable from the write/only interface 208. In another embodiment the read/write media 212 is permanently attached or associated with the write/only interface 208. In such an embodiment the write/only interface 208 may be replaced with a read/write interface (not shown).

It is contemplated that at or before a time Ti, the gaming machine 200 is played or operated in a usual manner. Operation of the gaming machine 200 generates operation data. The operation data is stored on the read/write media 212 via the write/only interface 208. If the read/write media 212 becomes full of operation data, last-in data may overwrite first in data. In this manner the read/write media 212 contains the most recent gaming machine 200 operation data.

If the gaming machine 200 malfunctions or crashes, the operation data just prior to and leading up to the malfunction is recorded on the read/write media, having been continually or intermittently received via the write/only interface 208. As a result of the recording that may occur in real time, that occurs from the gaming machine 200 to the read/write media 212, the operation data is thus stored for analysis by qualified personal to determine the cause and the remedy for the malfunction. It is contemplated that the operation data comprise sufficient detail regarding sufficient aspects of the gaming machine 200 for analysis to reveal the cause of the malfunction.

At or after a time T2, illustrated in the lower half of FIG. 2, the read/write media 212 may be removed from the write/only interface 208 and provided to a read/write interface 224. The read/write interface 224 is capable of reading the operation data stored on the read/write media 212. The read/write interface 224 connects to or communicates with a computer 228, or other terminal device so that the data may be analyzed by a service technician, engineer, or other qualified personal. It is further contemplated that the write/only interface 208 may be accessed or communicated with over a data network thereby eliminating the need for a read/write media 212. If the read/write media 212 is permanently attached to the write/only interface 208 the entire write/only interface 208 may be removed from the gaming machine 200. In such an embodiment, the write/only interface 208 may be configured as a read/write interface 224.

One advantage of the invention is that the read/write 212 media may be analyzed at any computer 228 that has a read/write interface 224. Another advantage of the invention is that the read/write media 212 may be removed from the write/only interface 208 and sent to a remote location for analysis. The sending may comprise sending of the actual media 212, or downloading the operation data on the media to an electronic file and e-mail or otherwise transmitting the data electronically.

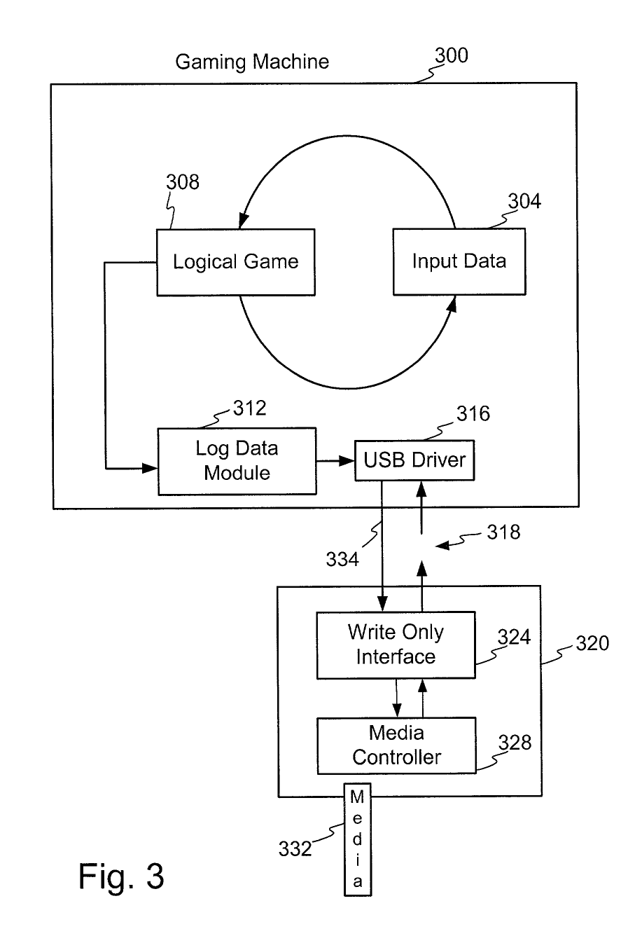

FIG. 3 illustrates a block diagram of one example implementation of the invention. As shown, a gaming machine 300 can be considered as having a logical game operation 308 as may be performed by a processor executing computer readable code to provide a gaming experience to a player. The player provides input data 304 in response to the logical game execution 308. Operation occurs in this cyclic operation to provide game play. At each stage or step of game play, operation data is generated and provided to a log data module 312. The log data module 312 may comprises any configuration or connection to the processor, conductors, traces, pin values, registers or software values or stage of software execution necessary to record as operation data the operation of the game or other aspect of the gaming machine 300. It is contemplated that the log data module 312 monitor and record any aspect of gaming machine operation (software and/or hardware) including but not limited to player tracking systems, bill validator systems, money receipt, payout, and tracking systems, display systems, user interface systems, network interface systems, security systems, or any other system as may now or in the future be included into or associated with a gaming machine. The log data module 312 may be configured to collect statistic information, logistic information, accounting information, and security information.

In the example embodiment shown in FIG. 3, the log data module 312 communicates with a universal serial bus (USB) 316 driver. The USB driver 316 comprises a compilation of hardware and software configured to communicate using the USB standard. Other communication standards and systems may be adopted without departing from the scope of the invention. The invention is not limited to a particular method or standard for communication. The USB driver 316 connects to a media interface 320 using an output line 334.

An input line 318 as might be use to write or transmit data from the media interface 320 to the gaming machine is shown as broken to indicate that data may only be transferred from the gaming machine 300 to the media interface 320. Any or all of the USB driver 316, the line 318, or the media interface 320 may be configured or modified to prevent data write operation from the media interface 320 to the gaming machine 300.

In the embodiment shown in FIG. 3, the media interface 320 comprises a write only interface 324 in communication with a media controller 328. The write only interface 324 is configured to only write data to a media 332 via the media controller 328. The media controller 328 oversees storage and interface with the media 332. In one embodiment the media 332 comprises a flash memory. In one embodiment the media 332 comprises a hard disk drive, either fixed or removable. It is contemplated that the media 332 may be removable or permanently mounted with the media interface 320.

Thus during operation of the gaming machine 300 the logical game 308 and input data 304 execute game play. As game play occurs and all the aspects of the gaming machine operate, the operation data is recorded by the log data module 312. It is contemplated that the log data module 312 may be controlled to selectively record or log data for only specified aspects of the gaming machine 300. The media interface 320 may be integrated within the gaming machine 300 or external to the gaming machine. If external, the media interface 320 may connect via one or more cables 344. A control cable (not shown) may also connect the media interface 320 to the gaming machine 300.

One advantage of the invention is that the operation of the media interface 320 and the log module 312 occurs generally independent of the logical game operation 308 and the input of data 304. Hence if the game malfunctions the data stored on the media 332 is not lost, such as data in volatile memory would be lost in a standard gaming machine or a computer.

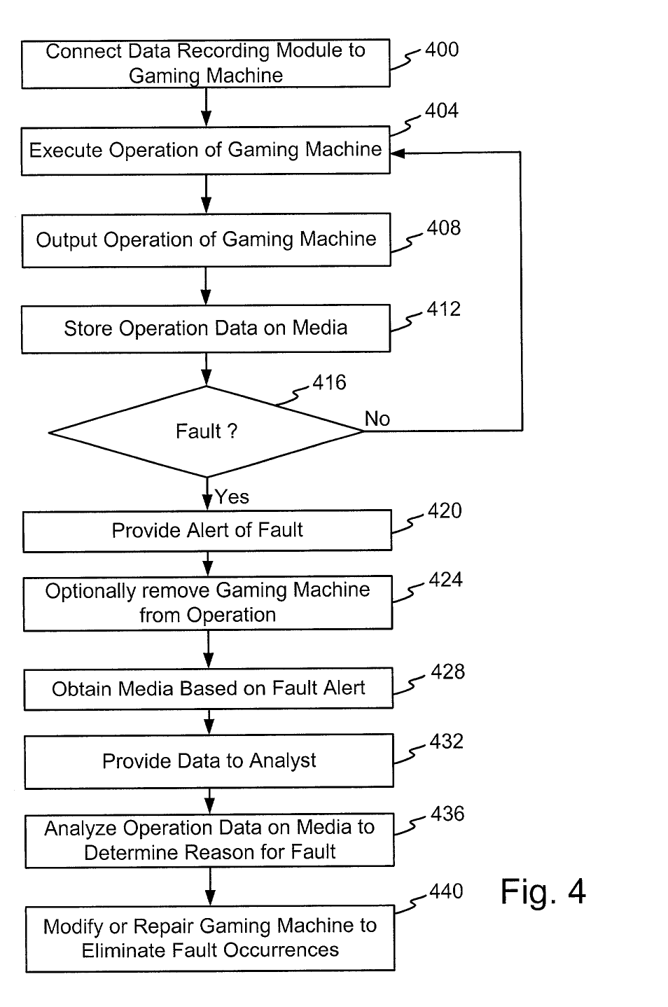

FIG. 4 illustrates an operational flow diagram of one example method of operation. Other methods of operation are contemplated and the method of FIG. 4 is provided for purposes of understanding as it illustrates initial steps and final analysis steps. For purposes of discussion, it may be assumed that a particular gaming machine is fault prone and hence often malfunctions. As a result, it is desired to monitor the malfunction and the events leading up to the malfunction. This is but one possible use for the invention and it is contemplated that other uses or methods of use exist. It is not required that the gaming machine to which the recording device is attached be malfunctioning. General monitoring and recording may be performed for any reason and at any time.

At a step 400 a data recording module is connected to a gaming machine. Any type of gaming device may be monitored including but not limited, to a video gaming machine, slot machine, reel-equipped machine, gaming network computer, wireless interface or wireless relay devices, player tracking device, bill acceptor, ticket printer, coin acceptor, light bezel device, and/or machine attract devices. It is contemplated that the data recording device may be manually connected and contained within a housing of the gaming machine or that the monitoring may automatically occur over a network link. In one embodiment a record-only device is located integral with a gaming machine and its operation is activated either by software or hardware control or by insertion of a media into the recording device.

At a step 404 the method executes game machine operation in a manner determined by the gaming machine. During game play, at a step 408, the gaming machine outputs operation data to an output port. At step 412 the data recording device receives the operation data and stores it on a media.

Next, at a decision step 416 the system determines if a fault has occurred. If a fault has not occurred then the method returns to a step 404 and the method repeats steps 404, 408, and 412. This method of operation occurs until a fault in gaming machine operation is detected. If or when a fault is detected at step 416, the operation proceeds to step 420 wherein an alert regarding the fault is provided to appropriate personal. In one embodiment the alert is provided to a computer technician to retrieve the media from the gaming machine. At a step 424 a technician or other person may optionally remove the gaming machine from operation so that a possibly fault prone gaming machine does not continue to malfunction during play. As an advantage of the invention, malfunctioning gaming machines are more likely to be removed from play thereby protecting the players from a malfunctioning gaming machine. Using the invention the gaming machine will more likely be removed from play because sufficient data has been collected from the machine with a single malfunction. Hence repeated use and malfunctions cycles are not necessary to determine the cause of the fault. Moreover, adequate operation data is collected to fix a gaming machine.

At a step 428 the media is obtained as a result of the fault alert. In various embodiments the media may be obtained by removing it from the data recorder which is attached to the gaming machine, the data may be downloaded or sent over a gaming network, Internet, or other computer network, or the media may be mailed to a remote location. It is also contemplated that step 428 may comprise removing the entire recording device from the gaming machine, such as if the media resides in the data recorder. At a step 432 the media, or the control data contained thereon, is provided to an analyst, technician or engineer and analyzed at a step 436. The control data may be analyzed to determine the reason for the fault and a potential alteration to the gaming machine or software code to prevent further faults. One method of analyzing comprises comparing the operation data to operation data from desired gaming machine operation. At a step 440 the gaming machine may be repaired or fixed as necessary.

Although the above-described method is discussed in relation to a malfunctioning gaming machine, it is contemplated that other uses for the data recording system may be adopted. These methods or reasons include, but are not limited to, increasing the performance of a gaming machine, play or player monitoring, game testing or fraud monitoring, security, gathering statistics, accounting, gathering demographic information, product failure analysis and/or marketing data.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A data recording module configured to record gaming machine operation data comprising:
one or more input ports configured to receive operation data from the gaming machine;
a write-only interface connected to at least one of the one or more input ports; and
a media interface connected to the write-only interface, the media interface configured to write gaming machine operation data to a media.

2. The data recording module of claim 1, wherein the media comprises a flash media.

3. The data recording module of claim 1, wherein the write-only interface comprises an interface operating in accordance with the universal serial bus standard.

4. The data recording module of claim 1, further including random access memory in communication with the write-only interface and the media interface, the random access memory configured to store the operation data prior to writing of the operation data to the media.

5. The data recording module of claim 1, further including a gaming machine, wherein the data recording module is integrally located within the gaming machine.

6. The data recording module of claim 1, further including a network interface wherein the network interface communicates with the write-only interface to transmit operation data over a data network.

7. A system configured to interface with a gaming machine and store data regarding gaming machine play, the system comprising:
gaming machine interface configured to collect operation data from the gaming machine and provide the operation data to an output interface of a gaming machine;
a write only device comprising:
an input interface configured to connect to the output interface and receive operation data; and
a media interface configured to communication with the input interface and write operation data to a media.

8. The system of claim 7, wherein the operation data comprises data selected from the group consisting of player tracking data, video data, money intake data and payout data.

9. The system of claim 7, wherein the output interface includes an output port driver.

10. The system of claim 7, wherein the system is integrated within a housing that also contains the gaming machine.

11. The system of claim 7, wherein the gaming machine interface connects to a processor.

12. The system of claim 7, wherein the input interface and the output interface operate under the universal serial bus standard

13. A method for recording data regarding gaming machine malfunction, the method comprising:
connecting a record-only data recording module to a gaming machine;
providing a media to the record-only data recording module;
executing game play; and
recording data regarding game play on a media.

14. The method of claim 13, wherein the media comprises a flash memory.

15. The method of claim 13, wherein data regarding game play comprises at least stack data.

16. The method of claim 13, further including overwriting first-in data with last-in data on the media when the media is full of data from recording data regarding game play.

17. A method for obtaining data concerning gaming system operation while preventing unauthorized writing of data to a gaming system, the method comprising:
establishing a communication link between a record-only data recording system and the gaming system;
initiating operation of the gaming system;
capturing data regarding gaming system operation; and
storing the data on a media, the media interfacing with the record-only data recording system over the communication link.

18. The method of claim 17, wherein the gaming system consists of a slot machine or video poker machine configured to provide a wagering event to a player.

19. The method of claim 17, wherein data regarding gaming system operation comprises system security data.

20. The method of claim 17, wherein the media comprises a hard-disk drive.

21. The method of claim 17, wherein the record-only data recording system is a record-only device only when connected to the gaming system and is a read/write device when connected to a device other than a gaming system.

22. The method of claim 17, further including;
obtaining data that is stored on the media;
analyzing the data; and
modify the gaming system based on the analyzing.

23. The method of claim 22, wherein analyzing the data comprises comparing the data to data resulting from desired gaming system operation.

24. The method of claim 22, wherein modifying comprises modifying the software/hardware of a gaming machine to achieve desired operation.
